(19) United States
(12) Patent Application Publication
(10) Pub. No.: US 2004/0174025 A1
(43) Pub. Date: Sep. 9, 2004

(54) Blow molded energy absorber for a vehicle front end

(75) Inventors: Thomas Converse, Lanesborough, MA (US); Eric D. Kowal, Roseville, MI (US); Vincent L. Lanning, Pittsfield, MA (US); Srikanth Santhanam, Windsor (CA); Stephen Shuler, Royal Oak, MI (US)

Correspondence Address: Robert E. Walter, General Electric Company, One Plastics Avenue, Pittsfield, MA, 01201, US

(73) Assignee: GENERAL ELECTRIC COMPANY

(21) Appl. No.: 10/715,749

(22) Filed: Nov. 18, 2003

Related U.S. Application Data
(63) Continuation-in-part of application No. 10/384,876, filed on Mar. 7, 2003.

(51) Int. Cl. B60R 19/34

(52) U.S. Cl. 293/133

(57) ABSTRACT

An blow molded energy absorber for a front bumper system on automotive vehicles is a molded unitary structure having a crushable forward projecting portion adapted to crush upon impact and rearward portion for attachment to a vehicle.

### CROSS REFERENCE TO RELATED APPLICATIONS

This application claims rights of priority under 35 U.S.C. 119 from U.S. patent application Ser. No. 10/384,876 filed on Mar. 7, 2003, which is incorporated herein by reference in its entirety.

### FIELD OF INVENTION

The field of invention relates to bumper systems that are adaptable to provide pedestrian protection in a bumper on an automotive vehicle.

### BACKGROUND OF THE INVENTION

Future legislation in Japan and European countries may require an energy absorbent design for a vehicle bumper system to help protection a pedestrian's legs from an impact.

Current bumper impact systems employ several separate components, which are assembled. Generally, these components include a soft energy absorber backed by stiff reinforcing beam to achieve US FMVSS and European ECE42 impact. The component parts of the energy absorber may be a thermoplastic resin or polypropylene foam adjacent a stiff supporting steel or aluminum beam. The beam is typically attached to vehicle rails with an energy absorber, in turn attached to the beam. An aesthetic fascia may be attached to the energy absorber or beam. Typically the fascia substantially envelops both the reinforcing beam and energy absorber. Typical components are a soft energy absorber backed by stiff reinforcing beam to achieve US FMVSS and European ECE42 impact. The bumper assembly comprises a reinforcing beam, which is configured to attach to vehicle rails, an energy absorber and a fascia attachable to the energy absorber or vehicle rails to substantially envelop the reinforcing beam and energy absorber.

### SUMMARY OF INVENTION

According to an embodiment, a blow molded energy absorber absorber includes thin walled crushable members which are adaptable for absorbing relatively low levels of energy such as in the area of pedestrian leg protection upon impact with the front end of an automotive vehicle. According to an embodiment, an elongated impact energy absorber comprises a blow molded thermoplastic having a forwardly projecting crushable portion extending longitudinally along the impact energy absorber. A rearward portion provides support for the forward crushable portion. According to an embodiment, the forwardly projecting portion includes thin walled sections for initiating at least the partial collapse of said forwardly projecting portion for absorbing a force impact. The support portion, adjacent the beam, may have thicker walls to provide stability at the juncture of the beam 19 and the energy absorber 13. The beam is typically attached to forwardly projecting rails which are directly connected to the frame of a vehicle.

Traditional vehicle bumper and bumper energy absorber systems have been designed to protect vehicle structures during low speed (about 5 miles per hour (mph) vehicle-to-vehicle or vehicle-to-solid structure impact. New legislation has been introduced in at least Europe and Japan to require a level of pedestrian protection upon impact with the front end of an automotive vehicle. The impact energy levels during such an occurrence are much lower than the traditional 5 mph vehicle bumper impacts. Therefore, systems designed for 5 mph vehicle bumper impact are too stiff to provide a sufficient level of pedestrian injury mitigation.

The energy absorber is adapted to minimize or mitigates pedestrian injury at low levels of speed and particularly pedestrian lower and upper leg injuries. The energy absorber is a blow molded with crushable portions, which may be adapted to quickly deform upon impact with a pedestrian thereby translating the force of impact to the energy absorber to protect the pedestrian. Blow molding permits the formation of thin walls for the crushable portions. The energy absorber bumper system may also comprise a fascia, the blow molded energy absorber and a reinforced bumper beam. The energy absorber design and blow molding process can also produce a thin walled structure that would be suitable to provide protection to vehicle structures during low speed (5 mph) vehicle impact or vehicle-to-vehicle solid structure impact.

### BRIEF DESCRIPTION OF THE DRAWINGS

FIG. 1 is a perspective view of the energy absorber showing sections A-A′ and B-B′.

FIG. 2 is a rear perspective view of the energy absorber.

FIG. 3 is a view along section A-A′ of of FIG. 1.

FIG. 4 is view along section B-B′ of FIG. 1.

FIG. 5 is an exploded perspective view illustrating the fascia, the energy absorber and bumper beam.

### DETAILED DESCRIPTION OF THE INVENTION

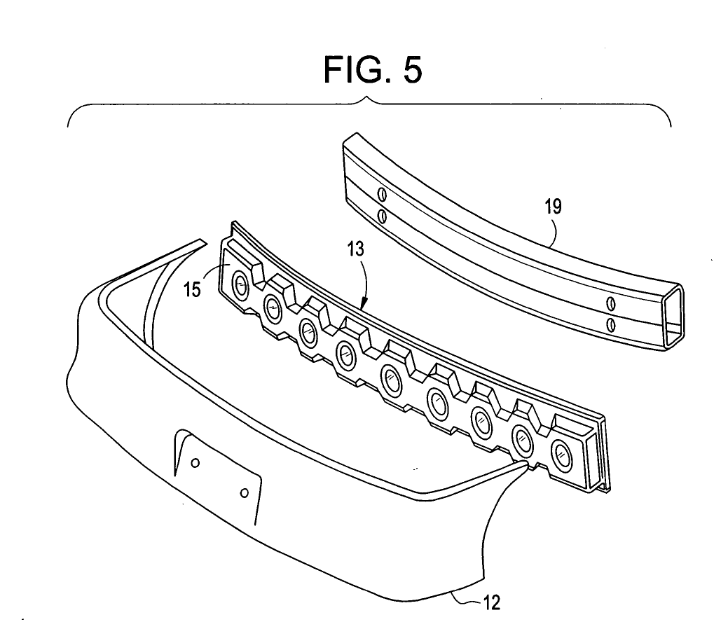

As shown in FIG. 5, energy absorber 13 which when combined with a reinforcing bumper beam 19 and a fascia 12 form an energy absorbing bumper system for an automotive vehicle. Depending on the wall thickness, the energy absorber 13 may be adapted for pedestrian protection during impact with the front bumper of a motor vehicle. Also, vehicle damage protection during vehicle to vehicle or vehicle to solid structure impact is a consideration. The energy absorber 13 includes a forwardly projection crushable portion 15 which incorporates hollow primary crush members 17 in the form of hollow protrusions from a support portion 23 having a flange 21. The crushable members 17 may be adapted to provide for lower and/or upper pedestrian leg protection during impact. The crushable members 17 desirable deform during impact for absorbing energy. During pedestrian impact, the energy absorption efficiency of the crushable portion 17 desirably reduces forces translated to a pedestrian's leg during impact. During vehicle to vehicle or vehicle to structure impact, the energy absorption efficiency of the crushable portion 17 reduces forces translated into the vehicle structure. The impact response of the energy absorber can be tuned for a specific vehicle through both the design of the energy absorber by varying crushable geometries, draft angles, crushable member spacing, and crushable member height, width, and length. The crushable members 17 may be varied in order to tune the energy absorber's impact response for specific impact energy levels Secondary crush means are generally situated on the backside of the energy absorber. The secondary crush means are fully described in the description of the drawings and are illustrated in the drawings.

The energy absorber 13 is blow molded from a thermoplastic resin. Typical thermoplastic resins include, but not limited thereto, polycarbonates, copolyester carbonates, polyphenylene ethers, polyurethanes, polyethylenes (high and low density) polypropylenes, elastomeric thermoplastics, and the like, and blends thereof with other polymers such as polycarbonate/polybutylene terephthalate, polyphenylene ether/high impact polystyrene, polycarbonate/acryconitrile-butadiene-styrene, and the like, and blends of the above polymers Generally, the preferred thermoplastic resin is a polycarbonate/polybutylene terephthalate combination sold by General Electric Company under the trademark XENOY® resin. While not preferred, fillers may also be employed with the thermoplastic used herein.

The blow molding process permits variations in wall thickness, which is desired features. Typically, blow molding permits thinner wall thickness than would typically be available from other molding techniques such as injection molding. Blow molding is a widely used process for the production of hollow thermoplastic shapes. The process is divided into two general categories: extrusion blow molding and injection blow molding. These processes are typically used to manufacture plastic containers. In extrusion blow molding, a parison or tube of plastic material is dropped or lowered from an extruder. Mold halves close around the parison, which is then expanded against the cavity wall by the injection of air or other gas. In injection blow molding, plastic is first injection molded into a preform, and the preform is then transferred to a blow mold where it is expanded. Since the entire energy absorber 13 is formed in a single molding operation from the same thermoplastic material, it may be desirable recycled.

The design geometry shown in the drawings, but not limited thereto, incorporates specific wall thickness which can range from about 0.25 mm to about 10 mm, and may have perimeter corrugation of width and depth, cones, cone draft angles, cone spacing, crush cans, and energy absorber height, width, and length. The thinner crushable portion 15 has a wall thickness from about 0.25 to about 4 mm, more preferably from about 0.5 to about 3 mm. The thicker support portion 23 has a wall thickness from about 0.5 to about 6 mm, more preferably from about 1 to about 4 mm. These can be varied in order to tune the energy absorber impact response for specific impact energy levels.

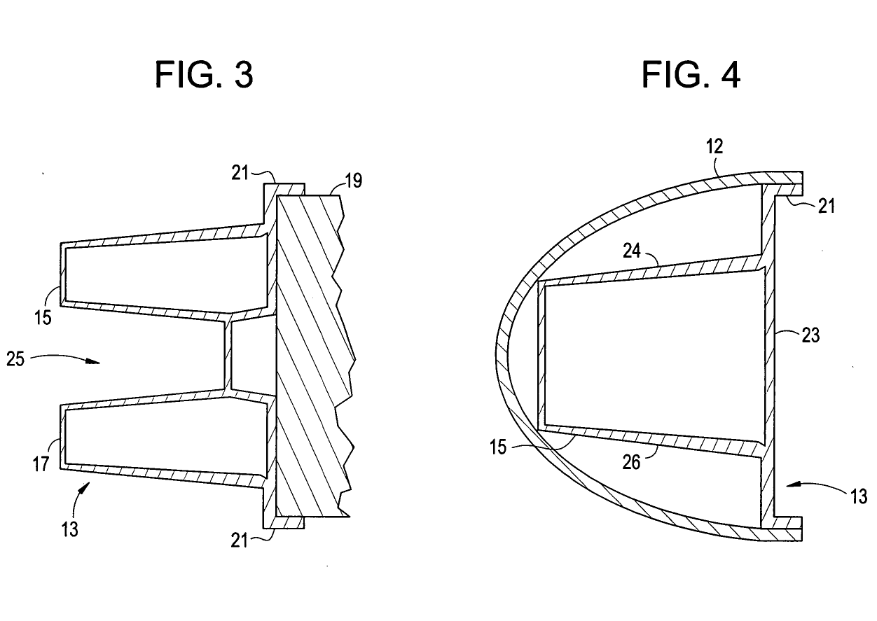

The energy absorber portion 13 incorporates forwardly projecting crushable members 17 which may be the form of lobes, cans or other geometries, which incorporate a desired functionality when molded. The crushable members 17 are desirably adapted to provide for protection of pedestrians on impact. Enhanced energy absorption efficiency of the crushable members 17 desirable reduces the forces translated into a pedestrian lower leg during impact. The forwardly projection crushable members 17 may be spaced apart along the length of the energy absorber 13. FIG. 3, shows beam 19 as being adapted for attachment to energy absorber 13. The beam 19 in turn is typically attached to respective supports or rails (not shown), which extend outwardly from the front of the vehicle and are typically attached to the vehicle frame.

The energy absorber design incorporates thin walled crushable members 17 having a wall thickness, which may be as thin as 0.5 mm. Energy absorption provided by crushable members 17, such as crush cans as shown in the drawings, reduces the force translated into a pedestrian upon impact. Another design element in the energy absorber of the instant invention is the attachment or touching off of the internal cone ends to the support portion 23 at a rear surface. These features aid in providing stability during the crush impact event. The design and blow molding process can also provide for vehicle structure protection during higher energy vehicle to vehicle or vehicle to solid structure impact events (around 5 mph).

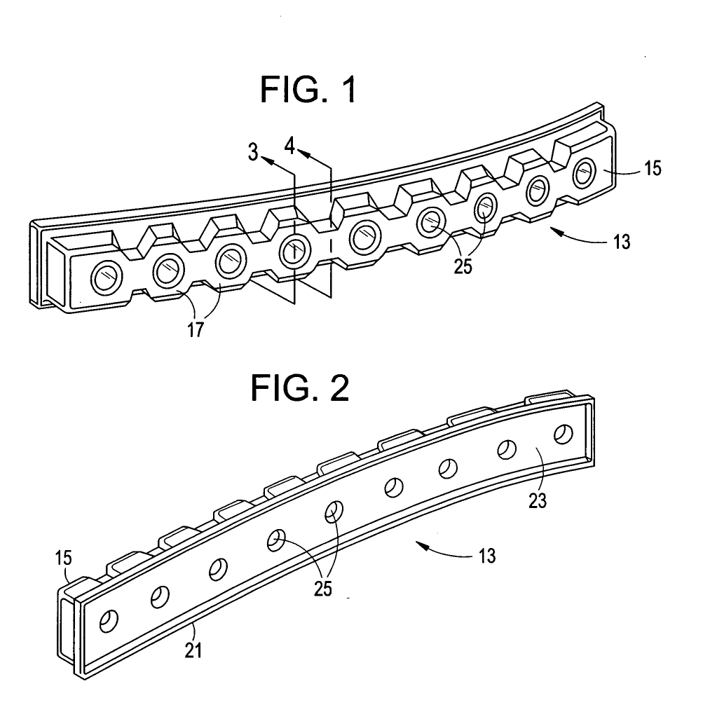

As shown in FIG. 2, the energy absorber 13 has a rearward facing support portion 23 in the form a rearward-facing surface. A flange 21 extends around the periphery of the surface and may be used for attachment of the energy absorber 13 to the beam 19. Holes may be are provided in the flange 21 for inserting fastening means such as bolts (not shown) to fixedly mount the energy absorber 13 to the bumper beam 19. FIG. 2 illustrates an energy absorber 13 embodiment having substantially equal spacing between respective crushable members 17. It is contemplated that other spacing may be utilized. A closer spacing and increasing the number of crushable members 17 may be a variable that is used to increase impact resistance. As shown in FIG. 1, each crushable member 17 includes a rear portion adjacent the support portion 23 and a front portion facing in a forward direction. The walls intermediate the front and rear portions are have a tapered or conically shape and connect the rear and front portions. The tapered configuration aids in the collapse of the crushable members 17. The front portion of the crushable member 17 terminates at a front wall, which is substantially parallel to and spaced from the rear surface of the support portion 23. The front wall extends longitudinally along the length of the energy absorber 13. The front wall or surface of the energy absorber 13 is adapted to contact the fascia 12 and deforms as the fascia moves against the energy absorber 13 to dissipate forces generated by impact of the bumper system with an object.

FIG. 3 is a view along cross section A-A′ of FIG. 2 and shows energy absorber 13 attached to reinforcing bumper beam 19 through holes (not shown) in flange 21 of energy absorber 13. Flange 21 illustrated in FIG. 2 and FIG. 3 is an integral part of energy absorber 13. As shown in FIG. 3, the cross section illustrates an embodiment where an upper portion of one of the crushable member 13 is separated from a bottom portion of the crushable member 13 by respective upper and lower walls, 24, 26, which extend in a transverse direction along the longitudinal axis of the energy absorber. Respective upper and lower walls, 24, 26, connect adjacent crushable members 17. As shown in FIG. 3, upper and lower walls form a channelor passageway between or joining of the interior potions of crushable members 13 so that the respective crushable members 13 co acts Upon impact and deformation. Forces causing deformation of one crushable member 13 are desirably transmitted to an adjacent crushable member 13 through the upper and lower walls 24, 26.

Referring to FIG. 1, there is illustrated a perspective view of energy absorber 13, support portion 23, peripheral flange 21, and crush members 13 which have an opening 25. The opening 25 does not extend all the way through energy absorber 13 and includes lateral wall intermediate the ends of the opening 25. FIG. 5, is illustrated a perspective and exploded view of each individual component parts of a vehicle front bumper system including fascia 12, energy absorber 13 and reinforcing bumper beam 19. When assembled, energy absorber 13 is positioned between fascia 12 and reinforcing bumper beam 19. Fascia 12 envelopes energy absorber 13 and reinforcing bumper beam 19 in the assembled form (not shown). Means may be provided to fixedly attach the energy absorber 13 to the bumper beam 19 such as bolts and nuts. Fascia 12 is maybe formed from a thermoplastic material, which, preferably, has a finished surface and may be amenable to finishing utilizing conventional vehicle painting and/or coating techniques. As stated, generally, the fascial 12 will envelop both the energy absorber 13 and reinforcing bumper beam 19 such that neither of the components, other than fascia 12, is visible once they are attached to the vehicle. The fascia 12 may be attached to the bumper beam 19 or other part of the vehicle.

FIG. 2 shows the spacing between the respective crush members 13. FIG. 2 illustrates an embodiment having substantially equal spacing between respective crushable members 13. As shown in FIG. 3 and FIG. 5, each crushable member 13 includes a rear lobe portion and a front lobe portion with the intermediate portion. Which is preferably tapered or conically shaped, connecting the rear and front. As illustrated in FIG. 1, the front portion has a smaller cross-sectional area than the rear portion so that the front portion tends to crush into the rear lobe portion. The front lobe portion 17 terminates at a lobe front wall, which is substantially parallel to and spaced from the face of the rear surface of the support portion 23. The front wall extends longitudinally along the length of the energy absorber 13. The front surface of the energy absorber 13 is adapted to contact the fascia 12 and deforms as the fascia moves against the energy absorber 13 and to dissipate forces generated by impact of the bumper system with an object.

FIG. 2 is a perspective view of the backside of energy absorber 13 showing the support portion 23 with an opening 25 in the rear surface. The opening 25 does not extend all the way through energy absorber 13. A cross wall or member is provided to close the opening 25 intermediate the ends. Flange 21 may be configured to snap fit or to attach to a the reinforcing bumper beam 19.

FIG. 5 is an illustration of the individual component parts of a vehicle bumper, namely fascia 12, energy absorber 13 and reinforcing bumper beam 19. Please note that crushable member 13 shown in FIG. 3 includes primary and secondary crush features. As shown, primary forward portion of the crushable member 17 is the first portion to deform upon impact while the rearward portion maintains integrity of the bumper. When the forward portion deforms upon initial impact, the rearward portion absorbs any residual impact forces thereby adding further protection to pedestrian and vehicle impact damage. In addition, structure of the crushable members 17 further aides in the process of blow molding the energy absorber by providing ease of repeatability in manufacturing the energy absorber of this invention.

While it will be apparent that the preferred embodiments of this invention as disclosed herein are well calculated to fulfill the objects stated, it will be appreciated that the invention is susceptible to modifications, variations and changes without departing from the spirit and scope of the present invention being limited only in terms of the appended claims.

What is claimed:

1. An energy absorber adapted for attachment to a vehicle for absorbing forces generated from an impact, said energy absorber comprising a blow molded unitary structure having a rearward facing support portion and a crushable forward projecting portion adapted to crush upon impact.

2. An energy absorber adapted for attachment to a vehicle for absorbing forces generated from an impact according to claim 1 wherein said energy absorber has an elongated shape and is adapted for mounting to the forward end of a vehicle for extending longitudinally across the width of the vehicle.

3. An energy absorber adapted for attachment to a vehicle for absorbing forces generated from an impact according to claim 2 wherein said energy absorber is adapted for pedestrian leg protection and has a highly efficient crush mode.

4. An energy absorber adapted for attachment to a vehicle for absorbing forces generated from an impact according to claim 2 is adapted to reduce forces of impact with legs of a pedestrian.

5. An energy absorber adapted for attachment to a vehicle for absorbing forces generated from an impact according to claim 2 wherein the energy absorber is adapted to absorb energy during an impact of said vehicle at low speeds of less than or equal to 5 Mph.

6. An energy absorber adapted for attachment to a vehicle for absorbing forces generated from an impact according to claim 2 said energy absorber consist essentially of a single integral unit of blow molded material.

7. An energy absorber adapted for attachment to a vehicle for absorbing forces generated from an impact according to claim 6 wherein said forwardly projecting portion comprises a plurality of forwardly projecting crushable members.

8. An energy absorber adapted for attachment to a vehicle for absorbing forces generated from an impact according to claim 7 wherein said energy absorber includes a support portion for said crushable lobes, said support portion being adapted for attachment to bumper beam.

9. An energy absorber adapted for attachment to a vehicle for absorbing forces generated from an impact according to claim 8 wherein said plurality of crushable members extend outwardly from the support portion, each of said crushable members having a forwardly facing front wall, at least a pair of adjacent lobes having interconnecting front walls.

10. An energy absorber adapted for attachment to a vehicle for absorbing forces generated from an impact according to claim 9 wherein said plurality of the crush means are attached longitudinally across the front of the support portion.

11. An energy absorber adapted for attachment to a vehicle for absorbing forces generated from an impact according to claim 10 wherein said plurality of crushable members project forwardly and are spaced apart longitudinally across said support portion.

12. An energy absorber adapted for attachment to a vehicle for absorbing forces generated from an impact according to claim 13 wherein said energy absorber comprises a thermoplastic resin.

13. An energy absorber adapted for attachment to a vehicle for absorbing forces generated from an impact according to claim 12 wherein said thermoplastic polymer comprises polyolefin, a polyester resin, a polycarbonate, or mixtures thereof.

14. An energy absorber adapted for attachment to a vehicle for absorbing forces generated from an impact according to claim 13 wherein said polyester is a polyalkylene terephthalate, a high density polyethylenes, a low density polyethylene, a polyamide or mixtures thereof.

15. An energy absorber adapted for attachment to a vehicle for absorbing forces generated from an impact according to claim 14 wherein said polyester is polybutylene terephthalate and said polycarbonate is an aromatic polycarbonate.

16. An energy absorber adapted for attachment to a vehicle for absorbing forces generated from an impact according to claim 10 wherein said energy absorber is interposed between the fascia and reinforcing bumper beam, said vehicle bumper being attachable to the front of an automotive vehicle, said fascia enveloping the energy absorber and reinforcing beam such that neither component other than the fascia is visible once attached to the vehicle.
